(19) United States
(12) Patent Application Publication
(10) Pub. No.: US 2020/0362285 A1
(43) Pub. Date: Nov. 19, 2020

(54) AROMATIZATION OF BEVERAGES

(71) Applicant: Schlenkerla "Heller Bräu" Trum KG, Bamberg (DE)

(72) Inventor: Matthias Trum, Bamberg (DE)

(73) Assignee: Schlenkerla "Heller Bräu" Trum KG, Bamberg (DE)

(21) Appl. No.: 16/414,013

(22) Filed: May 16, 2019

(51) Int. Cl. C12G 3/06

(52) U.S. Cl. CPC C12G 3/06; C12G 2200/21

(57) ABSTRACT

The present disclosure relates to the aromatization and/or coloring of liquids, particularly alcoholic liquids with kilned malt components.

### BACKGROUND

Consumers demand an intense color and a full-bodied taste of many alcoholic beverages. A possibility of imparting alcoholic beverages, particularly spirits or brandies with a dark color and a full-bodied flavor is to store the beverage in a wooden barrel over a longer period of time. By doing so, the beverage acquires a dark color and a woody or smoky taste. Well known are, e.g., whiskies stored in a wooden barrel for many years. However, this storage is time-consuming. Thus, often storing over several months or years is required so that the beverage acquires the desired color and/or the desired flavor.

### SUMMARY

Described herein are methods of aromatizing and/or coloring an alcoholic liquid. A method of aromatizing and/or coloring an alcoholic liquid as described herein comprises the steps of a) providing an alcoholic liquid and b) mixing the alcoholic liquid with kilned malt components for a reaction time to provide a final product. Optionally, the alcoholic liquid is a beverage. The malt components optionally comprise one or more of barley malt components, wheat malt components, spelt malt components, rye malt components and/or corn malt components, particularly barley malt components. Optionally, the kilned malt components comprise one or more of malt culms, malt shells, malt husks, and draff, particularly malt culms, malt shells or malt husks. In some cases, the kilned malt components (e.g., kilned malt culms) are dried at a temperature of 30° C. to 110° C. Optionally, the malt components are exposed to smoke during kilning to prepare the kilned malt components.

The alcoholic liquid can contain at least 20 wt. % ethanol. In some examples, the alcoholic liquid comprises a brandy or spirit (e.g., a grain-based brandy or spirit). Optionally, the alcoholic liquid in step a) is provided with an alcohol content which is 1 to 5 wt. % higher than the alcohol content of the final product. The alcoholic liquid is optionally a Bierbrand or a whiskey.

In some cases, the alcoholic liquid is mixed for 1 hour to 100 days with the kilned malt components. Optionally, an amount of the kilned malt components (e.g., malt culms) added to the alcoholic liquid in step b) is from 1 g/l to 100 g/l of the alcoholic liquid. Optionally, the kilned malt components (e.g., malt culms) are added to the alcoholic liquid in a bag or container and removed again together with the bag or container after a reaction time. The methods described herein can further comprise the steps of c) removing the kilned malt components (e.g., malt culms) from the alcoholic liquid and/or d) adjusting the alcohol content of the final product to a final strength.

Also described herein are methods of aromatizing and/or coloring an alcoholic liquid comprising the steps of a) providing an alcoholic liquid; and b) mixing the alcoholic liquid with kilned malt culms for a reaction time to provide a final product. Optionally, the alcoholic liquid is a beverage. Optionally, the kilned malt culms comprise one or more of barley malt culms, wheat malt culms, spelt malt culms, rye malt culms and/or corn malt culms. In some cases, the kilned malt culms are barley malt culms.

Also described herein are methods for aromatizing and/or coloring a liquid comprising the steps of a) providing a liquid; and b) mixing the liquid with kilned malt components for a reaction time to provide a final product.

Further described herein are compositions prepared from the methods described herein, such as an aromatized and/or colored alcoholic liquid prepared from the methods described herein.

The details of one or more embodiments are set forth in the description below. Other features, objects, and advantages will be apparent from the description and from the claims.

### DETAILED DESCRIPTION

The present disclosure relates to the aromatization and/or coloring of liquids, and particularly beverages comprising kilned malt components.

The present disclosure particularly relates to the aromatization and/or coloring of alcoholic liquids, in particular beverages, and particularly spirits, with kilned malt culms.

As noted above, storage of alcoholic liquids for long periods of time is typically required for achieving the desired color and/or the desired flavor. It was therefore an object of the present disclosure to provide a method of aromatizing and/or coloring liquids and particularly beverages in a simple, quick and feasible manner.

This object is solved according to the present disclosure by a method of aromatizing and/or coloring an alcoholic liquid comprising the steps of a) providing an alcoholic liquid and b) mixing the alcoholic liquid with kilned malt components.

Preferred is a method of aromatizing and/or coloring an alcoholic liquid, particularly an alcoholic beverage, comprising the steps of a) providing an alcoholic liquid, particularly an alcoholic beverage and b) mixing the alcoholic liquid, particularly the alcoholic beverage with kilned malt culms.

According to the disclosure herein, kilned malt components and preferably kilned malt culms are used for aromatizing and/or coloring alcoholic liquids. For the production of malt, grain is steeped in water as usual. In the course of the malting process the watered, i.e. soaked grain typically germinates for a few days. During malting a seedling grows out of the grain. This seedling is usually about ¾ of a grain long, i.e. about 0.5 to 1.5 cm long. Upon malting the grain, which is now termed green malt, is dried on the drying kiln. Thus kilned malt is obtained. During drying on the drying kiln also the seedling dries out. To ensure that the finished malt is storable and does not absorb moisture, the dried seedlings, which are termed malt culms, must be removed. Then the malt is further processed for the intended purpose, e.g., for beer brewing. The malt culms are a by-product or waste product in the production of malt. Primarily, malt culms have been further used as animal feed or fertilizer so far.

According to the present disclosure, it was now detected that with malt components and particularly malt culms, which have been regarded merely as by-product or waste product so far, beverages and particularly alcoholic beverages can be aromatized and/or colored in a simple manner.

According to the present disclosure kilned malt components are used for aromatizing and/or coloring liquids. The kilned malt components are particularly malt culms, malt shells, malt husks or draff Preferably according to the present disclosure not the entire malt kernel is used, but merely parts thereof. Particularly kilned malt components are used, which were separated from the starchy malt kernel. Therewith improved aromatization and coloring, respectively, is obtained, while at the same time the loss of moisture of the product absorbed by the starchy core of the malt kernels, is minimized. Husks, shells or malt culms separated from the starchy kernels are preferably used as kilned malt components. The kilned malt components used according to the present disclosure are thus most preferably completely free from the starchy core of the malt kernels.

According to the present disclosure, preferably kilned malt culms are used and particularly kilned malt culms which are separated from other malt components, particularly the malt kernels such that exclusively the malt culms are used.

The malt components are preferably barley malt components, wheat malt components, spelt malt components, rye malt components and/or corn malt components, particularly barley malt components.

The malt culms are preferably grain malt culms and preferably barley malt culms, wheat malt culms, spelt malt culms, rye malt culms and/or corn malt culms. According to the present disclosure particularly preferred barley malt culms are used.

For the production of the kilned malt components used according to the disclosure herein and preferably kilned malt culms, the green malt is kilned. Therein the green malt is dried, particularly at a temperature of about 30° C. to about 110° C. During the kilning process the green malt particularly of a moisture content of about 40 to 45 wt. % is adjusted to a moisture content of about 2 to 5 wt. %.

For example, first drying at a temperature of about 30° C. to about 40° C. can be performed, wherein most of the water is removed from the green malt in form of steam. During the so-called breakthrough the temperature rises. The higher the kilning temperature, the darker the malt obtained. Thus, for light beer types, such as Pilsner, usually kilning temperatures of 60° C. to 70° C. are maintained. For dark beer types the kilning temperature is usually 90° C. to 110° C.

In a most preferred embodiment, the kilning of the green malt is performed directly over open fire, particularly preferred over burning beech wood logs. Therein the green malt is dried by the hot air of the fire and obtains a typical smoky flavor from the smoke. In this embodiment the kilning temperature is preferably between 90° C. and 110° C.

The dried green malt can optionally be further roasted, for example at temperatures of 300° C. to 400° C. This way a very dark malt is obtained.

According to the disclosure herein, after kilning and optionally roasting the kilned malt components to be used are separated from the remaining malt components, particularly from the starchy core of the malt kernel.

According to the disclosure herein, after kilning and optionally roasting preferably the malt culms are separated from the malt.

The thus obtained kilned malt components and particularly the thus obtained kilned malt culms are added to an alcoholic liquid, particularly an alcoholic beverage according to the present disclosure.

The amount of kilned malt components and preferably of kilned malt culms added to the alcoholic liquid is preferably at least 1 g, more preferably at least 5 g, even more preferably at least 10 g and most preferably at least 15 g and up to 100 g, preferably up to 50 g, more preferably up to 25 g of kilned malt culms per liter alcoholic liquid.

Maceration, fermentation and optionally distillation to provide an alcoholic liquid can be performed according to known methods. In general, the alcoholic liquid treated according to the methods described herein can be any liquid containing a certain alcohol content, particularly ethanol. Preferably the alcoholic liquid applied according to the methods described herein exhibits an alcohol content of at least 4 wt. %, more preferably at least 8 wt. %, even more preferably at least 15 wt. %, further preferably of at least 20 wt. %, even more preferably at least 30 wt. % and most preferably of at least 40 wt. %. In general, the alcoholic liquid treated according to the methods described herein can be pure alcohol. Then same can be adjusted to the desired final strength of the product (i.e. the final alcohol content of the product) by diluting with water. However, preferably the alcohol content of the alcoholic liquid provided in step a) of the method described herein amounts to up to 80 wt. %, more preferably up to 60 wt. % and most preferably up to 45 wt. % alcohol.

Preferably, the alcohol of the alcoholic liquid provided in step a) of the method described herein amounts to 1 to 5 wt. %, more, preferably 1 to 3 wt. % more than the desired final strength of the product. This way, if at all, later on only little dilution with water is required to adjust the final strength of the product.

According to the present disclosure, it was now detected that by mixing an alcoholic liquid with kilned malt components and particularly kilned malt culms, an extraction of color and/or flavor from the malt components and particularly the malt culms occurs and the alcohol and the alcoholic liquid is colored and aromatized thereby. In particular, the alcoholic liquid obtains an amber color and a mild smoky flavor.

Using the method described herein thus all alcoholic liquids, particularly alcoholic beverages can be treated, which shall be imparted with a dark color and/or a strong smoky flavor. In particular, by using the method described herein a whiskey-like color or whiskey-like flavor can be imparted.

Hence, the method according described herein can applied, e.g., for the aromatization of wine. It is also possible to aromatize and/or impart a darker color to beer by using the method described herein. However, preferably, the method as described herein is applied for aromatizing and/or coloring spirits or liqueurs. Particularly preferred it is applied for the treatment of brandies, e.g., fruit brandies, spirits, e.g., fruit spirits, vodka, grain spirit, brandy, grappa, schnapps, whiskey (the terms whiskey and whisky are used interchangeably herein) or Bierbrand. Bierbrand is a spirit distilled from beer, i.e. a spirit distilled from grain and from hops. Bierbrand is sometimes also named beer spirit. Particularly advantageously, the method described herein is applied for aromatizing and/or coloring colorless brandies or spirits. Most preferred is the treatment of grain-based brandies or spirits, e.g., grain spirit, whiskey or Bierbrand and most preferred is the treatment of Bierbrands or whiskeys.

For the treatment of brandies or spirits, the alcoholic beverage used is preferably applied having an alcohol content about 1 to 3 wt. % higher than the final alcohol content of the product. Thus, the color obtained by the addition of malt components and particularly the addition of malt culms is not too strongly affected by a later dilution.

Adding the kilned malt components and particularly the kilned malt culms to the alcoholic liquid can be performed in various ways. Preferably, the kilned malt components and particularly the kilned malt culms are added in a container or bag, which is permeable to the alcoholic liquid. Thus, the extraction of color and/or flavor from the kilned malt components and particularly the kilned malt culms can occur by the alcohol and, moreover, the kilned malt components and particularly the kilned malt culms can be removed from the liquid in a simple manner at the end of the reaction time. Particularly preferred is the use of linen bags. However, it is also possible to simply add the kilned malt components and particularly the kilned malt culms to the alcoholic liquid, wherein then a separation can occur after the intended reaction time, e.g., by using filtration.

However, it is also possible to add the kilned malt components and particularly the kilned malt culms to the alcoholic liquid as extract or powder and leave it in the alcoholic liquid, hence, the product or to remove it after the desired reaction time, e.g., by using filtration.

It is further possible to boil the kilned malt components and particularly the kilned malt culms, e.g., in water and then add the boiled solution or an extract formed therefrom to the alcoholic liquid.

It is also possible to pass the alcoholic liquid through the kilned malt components and particularly the kilned malt culms, thus effecting aromatization and/or coloring.

Preferably, the kilned malt components and particularly the kilned malt culms are removed from the alcoholic liquid as soon as the desired coloring and/or aromatization has occurred. The reaction time thereby is usually 1 hour to 100 days, preferably 5 hours to 50 days, more preferably 10 hours to 14 days and most preferably 12 hours to 5 days.

The treatment of the alcoholic liquid with kilned malt components and particularly kilned malt culms can be performed at room temperature and particularly at temperatures of 5 to 30° C., preferably 10 to 25° C.

It was found that already in case of short reaction times a significant coloration and aromatization of alcoholic beverages occurs.

Due to the short reaction time the loss of alcohol during aromatization and coloration is minimal, particularly <1 wt. %. In contrast thereto, in case of a storage in a wooden barrel over several years a significant loss arises, the so-called “Angels' Share”.

The loss of alcohol, which can occur in the method described herein, is essentially due to the material of the bag or container, i.e., only the amount of alcohol which absorbed by the bag, e.g., linen bag. Since the bag or container can be used for the aromatization of further batches, these losses can be further minimized.

After optional removal of the malt components and particularly the malt culms, the alcoholic liquid can be adjusted to the final strength of the product with water as usual and optionally be filtrated.

A further subject matter described herein is an alcoholic liquid, particularly an alcoholic beverage, which is produced according to the method as described herein.

Using the method described herein compared to maturing in wooden barrels, similar flavors and particularly smoky flavors and/or whiskey-like flavors can be imparted to beverages and particularly alcoholic beverages extremely quickly and with extremely little loss. Moreover, it is possible to create spirits and liqueurs having a completely new taste.

Particularly good results in view of taste and color are obtained for Bierbrands, since by using the malt of the respective beer an ideal flavor combination is given. By varying the malt component concentration and particularly the malt culm concentration and the reaction time, the color and the aromatization of an alcoholic beverage and particularly of brandies or spirits can be adjusted.

It is further preferred to apply various malt types and particularly malt culm types in order to obtain different aromatizations and/or colorations.

It is also possible according to the methods described herein to mix malt components and particularly malt culms of different malt types. It is further possible to apply different temperature ranges during kilning or roasting in order to obtain desired flavors, e.g., roasting at elevated temperature to create coffee flavors.

Mixing the liquid, particularly the alcoholic liquid with kilned malt components and particularly kilned malt culms according to step b) of the method described herein can be performed by simply adding and soaking. However, it is also possible to actively mix the alcoholic liquid to which kilned malt components and particularly malt culms are added, e.g., with a stirrer, a circulation pump or the like.

Furthermore, for non-alcoholic beverages, e.g., tea or coffee, often a strong smoky flavor is desired.

Herein described is therefore a method of aromatizing and/or coloring a liquid comprising the steps of a) providing a liquid and b) mixing the liquid with kilned malt components.

In this embodiment, non-alcoholic liquids, particularly non-alcoholic beverages and preferably liquids, which are brewed, can be aromatized or colored, respectively. In this embodiment the method is particularly applied for aromatizing and/or coloring tea, coffee or other beverages to be brewed.

Preferably, therefor kilned malt components, preferably kilned malt culms are filled into a tea bag together with tea or tea blends, such that by brewing the tea bag, the tea is additionally colored or aromatized, particularly with a smoky taste or a whiskey-like taste. Similarly, kilned malt components and particularly kilned malt culms can be filled into coffee pods together with coffee or coffee blends, such that by brewing coffee with hot water they impart a smoky and particularly whiskey-like flavor to the finished coffee beverage.

Preferably at least 1 g, more preferably at least 5 g, even more preferably at least 10 g and most preferably at least 15 g and up to 100 g, preferably up to 50 g and even more preferably up to 25 g of kilned malt components are used per liter liquid.

When during the process the kilned malt components are added to a non-alcoholic liquid, in the further manufacturing process for providing the final product, particularly a beverage to be consumed, there is no further step wherein alcohol is generated, particularly no fermentation step.

A further subject matter of the present application is a liquid, particularly a beverage, which is produced according to the method described herein and particularly exhibits a whiskey-like flavor.

When malt components as described herein are added to a non-alcoholic liquid, the product is preferably a liquid, particularly a beverage which does not contain any alcohol and exhibits a smoky flavor and/or a dark yellow to amber color.

For aromatizing and/or coloring an alcoholic liquid the water used for adjustment to the final strength of the product can be used in addition to or instead of aromatizing and/or coloring the alcoholic liquid itself. Thus, the water is aromatized or colored with kilned malt components and particularly kilned malt culms and this water is then added to an alcoholic liquid in order to aromatize or color same.

The example below is intended to further illustrate certain aspects of the methods and compositions described herein, and are not intended to limit the scope of the claims.

### EXAMPLES

### Example 1

Malt culms (2 kg; 20 g malt culms/L distillate) packed in a linen bag were introduced into 100 L of conventionally produced Bierbrand. The alcohol content of the Bierbrand was 42 wt. %. After a reaction time of 2 days, the Bierbrand exhibited a vivid amber color and a mild smoky flavor. After 2 days, the linen bag containing the malt culms was removed. The loss of alcohol detected was minimal and amounted to less than 1 wt. %. After removing the malt culms, the colored and aromatized Bierbrand was adjusted to 40 wt. % alcohol and filtrated.

The methods and compositions of the appended claims are not limited in scope by the specific methods and compositions described herein, which are intended as illustrations of a few aspects of the claims and any compounds and methods that are functionally equivalent are within the scope of this disclosure. Various modifications of the methods and compositions in addition to those shown and described herein are intended to fall within the scope of the appended claims. Further, while only certain representative methods, compositions, and aspects of these methods and compositions are specifically described, other methods and compositions are intended to fall within the scope of the appended claims. Thus, a combination of steps, elements, components, or constituents can be explicitly mentioned herein; however, all other combinations of steps, elements, components, and constituents are included, even though not explicitly stated.

What is claimed is:

1. A method of aromatizing and/or coloring an alcoholic liquid comprising the steps of:
a) providing an alcoholic liquid; and
b) mixing the alcoholic liquid with kilned malt components for a reaction time to provide a final product.

2. The method according to claim 1, wherein the alcoholic liquid is a beverage.

3. The method according to claim 1, wherein the kilned malt components comprise one or more of barley malt components, wheat malt components, spelt malt components, rye malt components, and corn malt components.

4. The method according to claim 1, wherein the kilned malt components comprise one or more of malt culms, malt shells, malt husks, and draff.

5. The method according to claim 1, wherein the kilned malt components are dried at a temperature of 30° C. to 110° C.

6. The method according to claim 1, wherein malt components are exposed to smoke during kilning to prepare the kilned malt components.

7. The method according to claim 1, wherein the alcoholic liquid contains at least 20 wt. % ethanol.

8. The method according to claim 1, wherein the alcoholic liquid comprises a brandy or spirit.

9. The method according to claim 1, wherein the alcoholic liquid in step a) is provided with an alcohol content which is 1 to 5 wt. % higher than the alcohol content of the final product.

10. The method according to claim 1, wherein the alcoholic liquid is a Bierbrand or a whiskey.

11. The method according to claim 1, wherein the alcoholic liquid is mixed for 1 hour to 100 days with the kilned malt components.

12. The method according to claim 1, wherein an amount of the kilned malt components added to the alcoholic liquid in step b) is from 1 g/l to 100 g/l of the alcoholic liquid.

13. The method according to claim 1, wherein the kilned malt components are added to the alcoholic liquid in a bag or container and removed again together with the bag or container after a reaction time.

14. The method according to claim 1, further comprising a step of:
c) removing the kilned malt components from the alcoholic liquid.

15. The method according to claim 1, further comprising a step of:
d) adjusting the alcohol content of the final product to a final strength.

16. An aromatized and/or colored alcoholic liquid prepared from the method according to

17. A method of aromatizing and/or coloring an alcoholic liquid comprising the steps of:
a) providing an alcoholic liquid; and
b) mixing the alcoholic liquid with kilned malt culms for a reaction time to provide a final product.

18. The method according to claim 17, wherein the alcoholic liquid is a beverage.

19. The method according to claim 17, wherein the kilned malt culms comprise one or more of barley malt culms, wheat malt culms, spelt malt culms, rye malt culms and/or corn malt culms.

20. A method for aromatizing and/or coloring a liquid comprising the steps of:
a) providing a liquid; and
b) mixing the liquid with kilned malt components for a reaction time to provide a final product.
